(19) United States
(12) Patent Application Publication
(10) Pub. No.: US 2025/0317590 A1
(43) Pub. Date: Oct. 9, 2025

(54) RECONSTRUCTION OF THE TRANSFORM COEFFICIENTS IN VIDEO CODING

(71) Applicant: Tencent America LLC, Palo Alto, CA (US)

(72) Inventors: Motong XU, Palo Alto, CA (US); Roman CHERNYAK, Santa Clara, CA (US); Tianqi LIU, Palo Alto, CA (US); Biao WANG, San Jose, PA (US); Ziyue XIANG, Palo Alto, CA (US); Lien-Fei CHEN, Palo Alto, CA (US); Yonguk YOON, Palo Alto, CA (US); Shan LIU, San Jose, CA (US); Yifan WANG, Palo Alto, CA (US)

(73) Assignee: Tencent America LLC, Palo Alto, CA (US)

(21) Appl. No.: 19/172,097

(22) Filed: Apr. 7, 2025

Related U.S. Application Data
(60) Provisional application No. 63/631,231, filed on Apr. 8, 2024.
(60) Provisional application No. 63/633,842, filed on Apr. 14, 2024.

(51) Int. Cl. H04N 19/44; H04N 19/105; H04N 19/124; H04N 19/176; H04N 19/18

(52) U.S. Cl. CPC H04N 19/44; H04N 19/105; H04N 19/124; H04N 19/176; H04N 19/18

(57) ABSTRACT

A video bitstream including coded information of a current block in a current picture is received. The coded information includes quantization step sizes and quantized levels associated with the current block. Whether a quantization step size of the quantization step sizes that is associated with a current quantized level of the quantized levels is zero is determined. When the quantization step size associated with the current quantized level is zero, a reconstructed transform coefficient associated with the current quantized level is determined based on a product of a sign associated with the current quantized level and a reconstruction magnitude associated with the current quantized level. The current block is reconstructed based on the reconstructed transform coefficient value.

### INCORPORATION BY REFERENCE

The present application claims the benefit of priority to U.S. Provisional Application No. 63/631,231, “ZERO LEVEL RECONSTRUCTION METHOD” filed on Apr. 8, 2024, and U.S. Provisional Application No. 63/633,842, “ADAPTIVE QUANTIZATION SHIFTING OFFSET BASED ON CODEWORD LENGTH” filed on Apr. 14, 2024. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods, and apparatuses for video encoding/decoding. In some examples, an apparatus for video encoding/decoding includes processing circuitry.

According to an aspect of the disclosure, a method of video decoding is provided. In the method, a video bitstream including coded information of a current block in a current picture is received. The coded information includes quantization step sizes and quantized levels associated with the current block. Whether a quantization step size of the quantization step sizes that is associated with a current quantized level of the quantized levels is zero is determined. When the quantization step size associated with the current quantized level is zero, a reconstructed transform coefficient associated with the current quantized level is determined based on a product of a sign associated with the current quantized level and a reconstruction magnitude associated with the current quantized level. The current block is reconstructed based on the reconstructed transform coefficient value.

According to another aspect of the disclosure, a method of video decoding is provided. In the method, a video bitstream including coded information of a current block in a current picture is received. The coded information includes quantized levels associated with the current block. An initial value of a current transform coefficient of the current block is determined based on a quantized level of the quantized levels that is associated with the current transform coefficient. An adjusted value of the current transform coefficient is determined based on a shift offset being applied to the initial value of the current transform coefficient. The current block is reconstructed based on the adjusted value of the current transform coefficient.

According to yet another aspect of the disclosure, a method of processing visual media data is provided. In the method, a bitstream of the visual media data is processed according to a format rule. The bitstream includes coded information of a current block in a current picture. The coded information includes quantization step sizes and quantized levels associated with the current block. The format rule specifies that whether a quantization step size of the quantization step sizes that is associated with a current quantized level of the quantized levels is zero is determined. The format rule specifies that, when the quantization step size associated with the current quantized level is zero, a reconstructed transform coefficient associated with the current quantized level is determined based on a product of a sign associated with the current quantized level and a reconstruction magnitude associated with the current quantized level. The format rule specifies that the current block is processed based on the reconstructed transform coefficient.

Aspects of the disclosure provide a method for video encoding. In the method, whether a quantization step size that is associated with a current quantized level of a plurality of quantized levels of a current block in a current picture is zero is determined. When the quantization step size associated with the current quantized level is zero, a reconstructed transform coefficient associated with the current quantized level is determined based on a product of a sign associated with the current quantized level and a reconstruction magnitude associated with the current quantized level. The current block is encoded based on the reconstructed transform coefficient.

Aspects of the disclosure provide a method for video encoding. In the method, an initial value of a current transform coefficient of a current block is determined based on a quantized level that is associated with the current transform coefficient. An adjusted value of the current transform coefficient is determined based on a shift offset being applied to the initial value of the current transform coefficient. The current block is encoded based on the adjusted value of the current transform coefficient.

Aspects of the disclosure also provide an apparatus for video decoding. The apparatus for video decoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

Technical solutions of the disclosure include methods and apparatuses for improving reconstruction accuracy by determining the transform coefficient value when the quantization level is zero and/or (ii) adaptively deciding shifting offset based on a codeword length of a quantized level. In an example, a video bitstream including coded information of a current block in a current picture is received. The coded information includes quantization step sizes and quantized levels associated with the current block. Whether a quantization step size of the quantization step sizes that is associated with a current quantized level of the quantized levels is zero is determined. When the quantization step size associated with the current quantized level is zero, a reconstructed transform coefficient associated with the current quantized level is determined based on a product of a sign associated with the current quantized level and a reconstruction magnitude associated with the current quantized level. The current block is reconstructed based on the reconstructed transform coefficient value. In an example, a video bitstream including coded information of a current block in a current picture is received. The coded information includes quantized levels associated with the current block. An initial value of a current transform coefficient of the current block is determined based on a quantized level of the quantized levels that is associated with the current transform coefficient. An adjusted value of the current transform coefficient is determined based on a shift offset being applied to the initial value of the current transform coefficient. The current block is reconstructed based on the adjusted value of the current transform coefficient. Thus, by (i) determining the transform coefficient value when the quantization level is zero and/or (ii) adaptively deciding the shifting offset based on the codeword length of the quantized level, coding accuracy is improved.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 is a schematic illustration of a first example of signs of neighboring nonzero quantized levels.

FIG. 5 is a schematic illustration of a second example of signs of neighboring nonzero quantized levels.

FIG. 6 is a schematic illustration of an example of sign hypotheses.

FIG. 7 is a schematic illustration of pixels in a current block and neighboring reconstructed blocks.

FIG. 8 shows a flow chart outlining a decoding process according to some aspects of the disclosure.

FIG. 9 shows a flow chart outlining an encoding process according to some aspects of the disclosure.

FIG. 10 is a schematic illustration of a computer system in accordance with an aspect.

### DETAILED DESCRIPTION

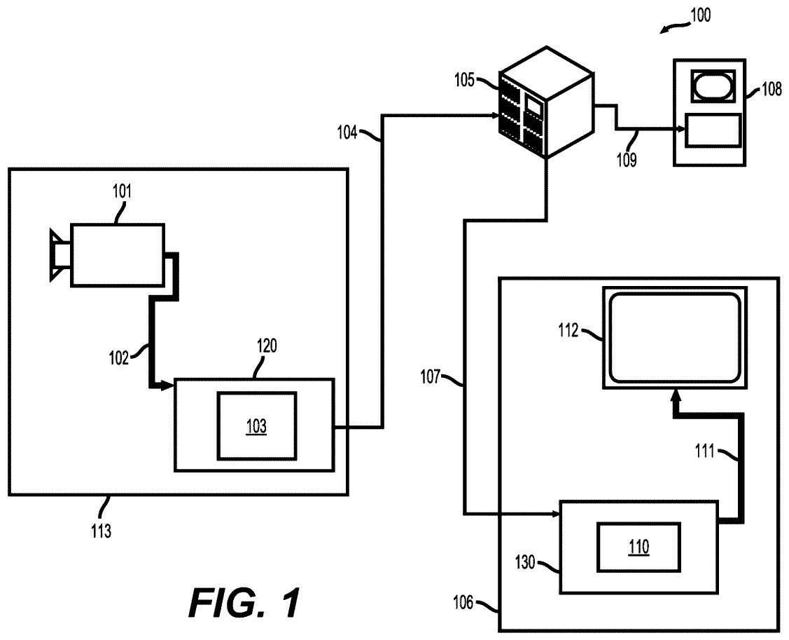

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

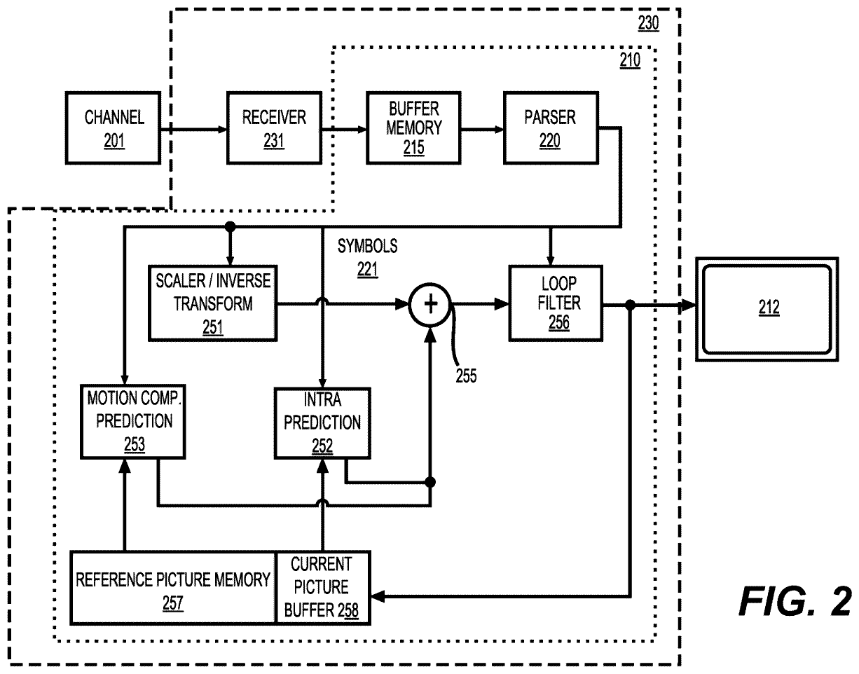

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

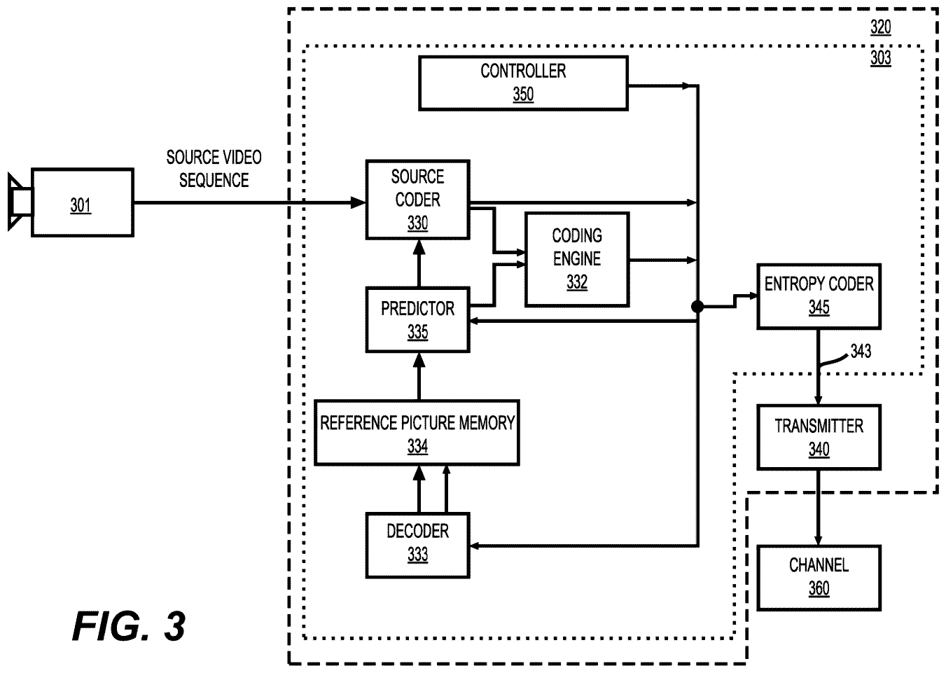

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques for reconstructing transform coefficients from zero quantized levels and/or adapting a quantizer center shifting offset based on a codeword length of a quantized level.

Image and video coding has been widely used in many applications, such as broadcasting, video recording, video streaming, etc. Many coding standards, such as JPEG, H.264, H.265/HEVC, H.266/VVC, and AV1 are published and widely adopted in these video applications. In an example, a hybrid video codec includes a plurality of coding modules, such as an intra prediction, an inter prediction, a transform coding, a quantization, entropy coding, and a post in-loop filter.

A video codec may encode/decode transform coefficients with a diagonal reverse z-scanning. Under a defined coefficient scanning order, a total number of coefficients to be decoded may be specified by signaling a position of a last significant coefficient.

In related video and image codecs, a reconstructed transform coefficient value

$${y}_{i}^{′}$$

may be obtained in equation (1) as follows:

$${y}_{i}^{′} = {x}_{i} \cdot {Δ}_{i} , \qquad Eq . ( 1 )$$

where xᵢ is a received quantized level (e.g., a quantized transform coefficient value) and Δᵢ is a quantization step size. When the received quantized level xᵢ=0, the reconstruction result

$${y}_{i}^{′}$$

may equal zero.

Aspects of the disclosure include methods of calculating reconstruction transformation coefficient values under zero quantized levels. When

$${x}_{i} = 0 , {y}_{i}^{′}$$

may be determined by a sign sign(i) and a reconstruction magnitude mᵢ as follows in equation (2):

$${y}_{i}^{′} = sign ( i ) \cdot {m}_{i} , \qquad Eq . ( 2 )$$

where the sign and/or magnitude may be predefined, signalled in a bitstream at one of a sequence level, a picture level, a slice level, a tile level, a block level, or the like, or derived from existing decoded information.

In an aspect, sign(i) is a predefined constant. In an example, the sign(i) is predefined as 1 and/or −1. In an example, sign(i)=1 or sign(i)=−1 is used in equation (2) for reconstruction of all zero coefficients (or zero transform coefficients) in a block when xᵢ=0. In an example, sign(i)=1 is used for zero quantized levels within a specific subblock/sub-region of a block, and sign(i)=−1 is used for zero quantized levels within other subblocks/sub-regions of the block.

In an aspect, sign(i) is derived from signs of already decoded neighbor quantized levels (or quantized transform coefficients), such as from the signs of neighboring reconstructed transform coefficients.

In an aspect, sign(i) is determined based on a majority of signs within neighboring nonzero quantized levels. In an example, sign(i) is determined as the majority of the signs within the neighboring nonzero quantized levels. In an example, sign(i) is determined as a most frequent one of the signs of the nonzero neighboring reconstructed transform coefficients.

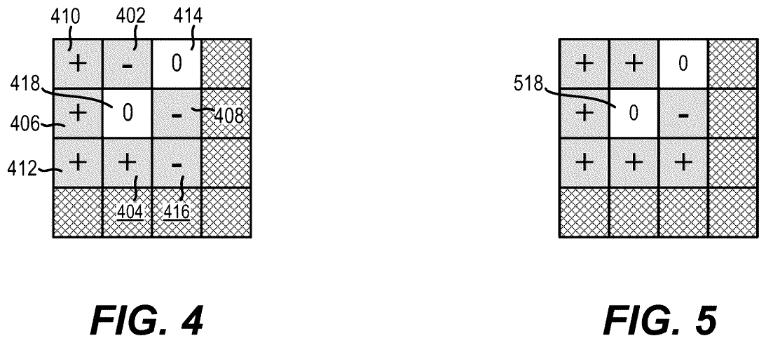

In an aspect, “neighbors” may be defined as a plurality of quantized levels adjacent to a current level. In an example shown in FIG. 4, the neighbors are defined as up to eight levels connected to the current level by an upper level (402), a lower level (404), a left level (406), a right level (408), an upper left (410), a lower left (412), an upper right (414), and a lower right (416). For a current zero level (418) at a position (1,1), a majority of neighboring signs of the current zero level (418) is positive, so sign (i)=1.

In an aspect, sign(i) is determined based on a percentage of neighboring signs.

In an example, sign(i) is determined as a majority of signs within neighboring nonzero quantized levels when a percentage of the majority of the neighboring signs is larger than a threshold P. Otherwise, when the percentage of the majority of the neighboring signs is equal to or less than the threshold P, sign(i) is set to zero.

In an example, the percentage threshold P=60%. As in FIG. 4, for the current zero level (418) at the position (1,1), a majority of neighboring signs of the current zero level (418) is positive with a percentage of 50% (4/8×100%), which is less than 60%. Accordingly, sign(i) of the current zero level (418) is set to 0.

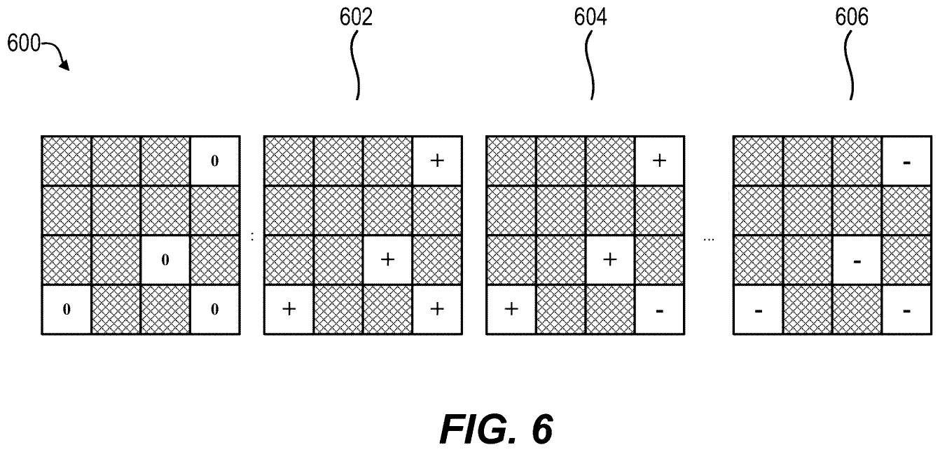

In an example, the percentage threshold P=60%. As in FIG. 5, for a current zero level (518) at a position (1,1), a majority of neighboring signs of the current zero level (518) is positive with a percentage of 75% (6/8×100%), which is larger than 60%. Accordingly, sign(i) of the current zero level (518) is set to 1.

In an aspect, several hypotheses (or candidates) of sign(i) settings are used for reconstruction zero quantized levels. A cost/is calculated from pixels inside a current block and neighboring reconstructed blocks. A hypothesis that provides a lowest cost/may be used as a final (or defined) sign(i) setting as shown in equation (3):

$$sign ( i ) = {arg min}_{k} ( J ) , \qquad Eq . ( 3 )$$

where k represents an index of different sign(i) setting hypotheses. For example, each of the hypotheses of sign(i) setting is applied to the current block to generate a set of reconstructed transform coefficients for the zero quantized levels in the current block. Each set of the reconstructed transform coefficients is further applied to the pixels of the current block to generate a candidate reconstructed sample values of the current block. A cost J is calculated based on a difference (e.g., mean square error (MSE), sum of absolute difference (SAD), mean absolute difference (MAD)) between the candidate reconstructed sample values of the current block and reconstructed samples of the neighboring blocks of the current block. A hypothesis corresponding to a lowest/may be selected.

In an example, n zero quantized levels are included in a block. A total number of hypotheses may be up to 2ⁿ. As illustrated in FIG. 6, a current block (600) corresponds to 16 quantized levels that include 4 zero quantized levels. In response to the 4 zero quantized levels in the current block (600), a total number of hypotheses (or sign (i) setting hypotheses) for these 4 zero quantized levels can be up to 24=16. For example, a first hypothesis (602), a second hypothesis (604) and a last (or sixteenth) hypothesis (606) are provided in FIG. 6. A final (or defined) sign(i) setting is determined as a hypothesis with a lowest cost J.

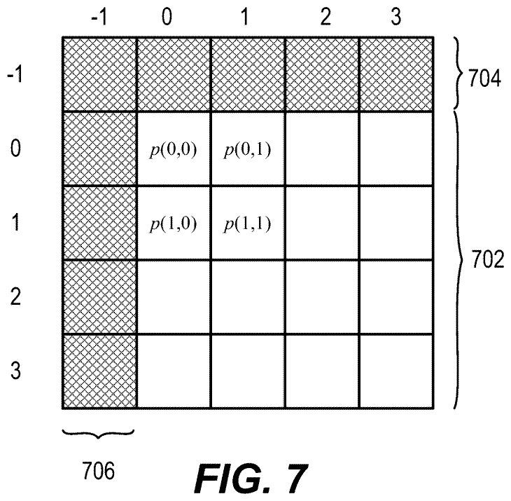

In an example, a cost J of a current hypothesis is calculated from (i) spatial domain reconstructed pixels of a current block that are reconstructed based on the current hypothesis and (ii) neighboring sample pixel values of the current block. FIG. 7 shows an example of a spatial domain reconstructed block (or reconstructed block) (702) that is reconstructed based on a hypothesis (or sign(i) setting hypothesis). As shown in FIG. 7, the reconstructed block (702) includes a row of neighboring sample pixels (704) at a top side of the reconstructed block (702) and a column of neighboring sample pixels (706) at a left side of the reconstructed block (702). The reconstructed block (702) further includes a plurality of pixels, such as p(0,0), p(0,1), p(1,0), and p(1,1).

In an example, a cost of one hypothesis is calculated as follows in equation (4):

$$J = {\sum }_{x = 0}^{M} \vert p ( x , 0 ) - p ( x , - 1 ) \vert + {\sum }_{y = 0}^{N} \vert p ( 0 , y ) - p ( - 1 , y ) \vert , \qquad Eq . ( 4 )$$

where M and N indicate a total number of pixels in a column and a row of a block. In an example shown in FIG. 7.

$${\sum }_{x = 0}^{M} \vert p ( x , 0 ) - p ( x , - 1 ) \vert$$

indicates a sum of absolute differences between pixels in a first column of the reconstructed block (702) and pixels in the column of neighboring sample pixels (706).

$${\sum }_{y = 0}^{N} \vert p ( 0 , y ) - p ( - 1 , y ) \vert$$

indicates a sum of absolute differences between pixels in a first row of the reconstructed block (702) and pixels in the row of neighboring sample pixels (704).

In an example, a cost of one hypothesis is calculated as follows in equation (5):

$$J = {\sum }_{x = 0}^{M} \vert p ( x , 1 ) - p ( x , - 1 ) \vert + {\sum }_{y = 0}^{N} \vert p ( 1 , y ) - p ( - 1 , y ) \vert , \qquad Eq . ( 5 )$$

In an example shown in FIG. 7,

$${\sum }_{x = 0}^{M} \vert p ( x , 1 ) - p ( x , - 1 ) \vert$$

indicates a sum of absolute differences between pixels in a second column of the reconstructed block (702) and pixels in the column of neighboring sample pixels (706).

$${\sum }_{y = 0}^{N} \vert p ( 1 , y ) - p ( - 1 , y ) \vert$$

indicates a sum of absolute differences between pixels in a second row of the reconstructed block (702) and pixels in the row of neighboring sample pixels (704).

In an example, the cost of one hypothesis is calculated as follows in equation (6):

$${\sum }_{x = 0}^{M} \vert 2 p ( x , 0 ) - p ( x , 1 ) - p ( x , - 1 ) \vert + {\sum }_{y = 0}^{N} \vert 2 p ( 0 , x ) - p ( 1 , y ) - p ( - 1 , y ) \vert , \qquad Eq . ( 6 )$$

In an example shown in FIG. 7, 2p(x,0)−p(x,1)−p(x,−1)=(p(x,0)−p(x,−1))+(p(x,0)−p(x,1)), which indicates a sum of (i) a difference between pixels in the first column of the reconstructed block (702) and pixels in the column of neighboring sample pixels (706) and (ii) a difference between the pixels in the first column of the reconstructed block (702) and the pixels in the second column of the reconstructed block (702). 2p(0,x)−p(1,y)−p(−1,y)=(p(0,x)−p(−1,y))+(p(0,x)−p(1,y)), which indicates a sum of (i) a difference between pixels in the first row of the reconstructed block (702) and pixels in the row of neighboring sample pixels (704) and (ii) a difference between the pixels in the first row of the reconstructed block (702) and the pixels in the second row of the reconstructed block (702).

In an aspect, mᵢ is a fixed value, such as a fixed positive value.

In an aspect, mᵢ is obtained depending on the quantization step size Δᵢ as follows in equation (7):

$${m}_{i} = f ( {Δ}_{i} ) , \qquad Eq . ( 7 )$$

where ƒ(⋅) denotes a function of Δ.

In an example, mᵢ is calculated as follows in equation (8):

$${m}_{i} = {b}_{1} \cdot {Δ}_{i} + {b}_{2} , \qquad Eq . ( 8 )$$

where b₁ and b₂ are two constant values.

In an example, mᵢ is obtained as follows in equation (9):

$${m}_{i} = \{ \begin{matrix}{b}_{1} , & {Δ}_{i} < T \\ {b}_{2} , & o therwise\end{matrix} , \qquad Eq . ( 9 )$$

where T is a threshold value.

In an aspect, mᵢ is obtained depending on a coefficient location (or transform coefficient location) as follows in equation (10):

$${m}_{i} = g ( i ) , \qquad Eq . ( 10 )$$

where g(⋅) denotes a function of a coefficient location i. In an example, the transform coefficient location in a block is indicated by a scan ID (or identifier) when the transform coefficients are scanned in the block. For example, in a 4×4 block, for a DC coefficient, the location is 0, and for a transform coefficient at a very bottom (e.g., a bottom right) position of the block, the location is 16−1=15.

In an example, mᵢ is calculated as follows in equation (11):

$${m}_{i} = {c}_{1} \cdot i + {c}_{2} , \qquad Eq . ( 11 )$$

where c₁ and c₂ are two constant values, i is a location of the transform coefficient yᵢ′.

In an example, mᵢ is obtained as follows in equation (12):

$${m}_{i} = \{ \begin{matrix}{c}_{1} , & i < T \\ {c}_{2} , & o therwise\end{matrix} \qquad Eq . ( 12 )$$

where T is a threshold value and i is a location of the transform coefficient

$${y}_{i}^{′} .$$

In an aspect of the disclosure, mᵢ is determined based on a location of a coefficient and is also correlated with a type of a transform kernel as follows in equation (13):

$${m}_{i} = {g}_{k} ( i ) , \qquad Eq . ( 13 )$$

where k denotes a kernel index/type.

In an aspect, mᵢ is obtained depending on neighboring levels (or neighboring quantized levels) within a same subblock or a same block.

In an example, mᵢ is calculated based on an absolute sum of neighboring levels. In an example, mᵢ is obtained as follows in equation (14):

$${m}_{i} = \{ \begin{matrix}{d}_{1} , & s < T \\ {d}_{2} , & otherwise\end{matrix} , where s = {\sum }_{j ∈ N} \vert {x}_{j} \vert , \qquad Eq . ( 14 )$$

where N is a set of the neighboring quantized levels, s is an absolute sum of the neighboring quantized levels, and T is a threshold value.

In related video and image codecs, reconstructed transform coefficient values yᵢ are firstly calculated from received quantized level (or quantized transform coefficient) xᵢ as follows in equation (15)

$${y}_{i} = {Q}^{- 1} ( {x}_{i} ) , \qquad Eq . ( 15 )$$

where

$${Q}^{- 1} ( \cdot )$$

denotes a reconstruction/dequantization process. Then, an initial reconstructed transform coefficient yᵢ obtained based on equation (15) may be shifted with a shifting offset

$${ρ}_{i}^{*}$$

as follows in equation (16):

$$\{ \begin{matrix}{y}_{i} ← {y}_{i} + {ρ}_{i}^{*} & when {y}_{l} > 0 \\ {y}_{i} ← {y}_{i} - {ρ}_{i}^{*} & when {y}_{l} < 0 \\ {y}_{i} ← {y}_{i} & when {y}_{i} = 0\end{matrix} , for i = 1 … n , \qquad Eq . ( 16 )$$

The shifting offset may be a fixed predefined value or depend on a value of the quantized transform coefficient xᵢ.

In an aspect of the disclosure, the shifting offset

$${ρ}_{i}^{*}$$

is adaptively decided based on a codeword length

$${C}_{{x}_{i}}$$

of a quantized level xᵢ. In an example, the codeword length ma refer to a total number of bits to represent a particular symbol or a particular piece of information in a compressed bitstream. The symbol may include a quantized transform coefficient, a motion vector, a prediction mode, a syntax element, or the like.

In an aspect, a shifting offset

$${ρ}_{i}^{*}$$

depends on a codeword length

$${C}_{{x}_{i}}$$

of a current quantized level xᵢ.

In an aspect, the

$${ρ}_{i}^{*}$$

is calculated from a function of

$${C}_{{x}_{i}}$$

as follows in equation (17):

$${ρ}_{i}^{*} = f ( {C}_{{x}_{i}} ) , \qquad Eq . ( 17 )$$

where ƒ(⋅) denotes a function of

$${C}_{{x}_{i}}$$

For example, ρ*ᵢ is calculated as follow in equation (18):

$${ρ}_{i}^{*} = {a}_{1} \cdot {C}_{{x}_{i}} + {a}_{2} , \qquad Eq . ( 18 )$$

where α₁ and α₂ are two constant values. In another example,

$${ρ}_{i}^{*}$$

is calculated as follows in equation (19):

$${ρ}_{i}^{*} = {a}_{1} \cdot {( {C}_{{x}_{i}} )}^{2} + {a}_{2} , \qquad Eq . ( 19 )$$

In an aspect, the ρ*ᵢ is obtained based on a value range of

$${C}_{{x}_{i}} .$$

In an example,

$${ρ}_{i}^{*}$$

is obtained as

$${ρ}_{i}^{*} = \{ \begin{matrix}\begin{matrix}\begin{matrix}{ρ}_{1} , {C}_{{x}_{i}} ∈ [ {r}_{0} , {r}_{1} ) \\ {ρ}_{2} , {C}_{{x}_{i}} ∈ [ {r}_{1} , {r}_{2} )\end{matrix} \\ …\end{matrix} \\ {ρ}_{n} , {C}_{{x}_{i}} ∈ [ {r}_{n - 1} , {r}_{n} )\end{matrix} \qquad Eq . ( 20 )$$

where ρ₁, . . . , ρₙ are different possible shifting offset values, and r₀, . . . , rₙ are positive integers that indicate a range of possible codeword lengths of

$${C}_{{x}_{i}} .$$

In an aspect, a lookup table is used to map the shifting offset

$${ρ}_{i}^{*}$$

value from the codeword length of xᵢ.

In an aspect, a shifting operation, such as the shifting operation in equation (16), is not applied when Cₓ_{ᵢ} equals to a specified value or within a specified range.

In an example, shifting is not applied when Cₓ_{ᵢ}=c. In an example, c is a predefined value for all transform coefficients. In an example, c is a predefined value that is adaptive to the transform coefficient location inside a block. In an example, c is signalled in a bitstream at one of a sequence level, a picture level, a slice level, a tile level, a block level, or other suitable levels.

In an example, shifting is not applied when Cₓ_{ᵢ}>c. In an example, shifting is not applied when Cₓ_{ᵢ}<c. In an example, shifting is not applied when c₁<Cₓ_{ᵢ}<c₂.

In an aspect, the shifting offset

$${ρ}_{i}^{*}$$

depends on a codeword length difference of the current quantized level xᵢ and another quantized value x′. The codeword length difference ΔC is denoted as follows in equation (21):

$$Δ C = {C}_{{x}^{′}} - {C}_{{x}_{i}} , \qquad Eq . ( 21 )$$

x′ can be equal to xᵢ+b, where b is a nonzero integer value and b may be predefined or signalled in a bitstream at one of a sequence level, a picture level, a slice level, a tile level, a block level, or other suitable levels.

In an aspect, the

$${ρ}_{i}^{*}$$

is calculated from a function of ΔC as follows in equation (22)

$${ρ}_{i}^{*} = f ( Δ C ) , \qquad Eq . ( 22 )$$

where ƒ(⋅) denotes a function of ΔC. In an example,

$${ρ}_{i}^{*}$$

is calculated as follows in equation (23):

$${ρ}_{i}^{*} = {a}_{1} \cdot Δ C + {a}_{2} , \qquad Eq . ( 23 )$$

where α₁ and α₂ are two constant values. In an example,

$${ρ}_{i}^{*}$$

is calculated as follows in equation (24):

$${ρ}_{i}^{*} = {a}_{1} \cdot {( Δ C )}^{2} + {a}_{2} , \qquad Eq . ( 24 )$$

In an aspect,

$${ρ}_{i}^{*}$$

is obtained based on a value range of ΔC. In an example,

$${ρ}_{i}^{*}$$

is obtained as follows in equation (25):

$${ρ}_{i}^{*} = \{ \begin{matrix}\begin{matrix}\begin{matrix}{ρ}_{1} , Δ C ∈ [ {r}_{0} , {r}_{1} ) \\ {ρ}_{2} , Δ C ∈ [ {r}_{1} , {r}_{2} )\end{matrix} \\ …\end{matrix} \\ {ρ}_{n} , Δ C ∈ [ {r}_{n - 1} , {r}_{n} )\end{matrix} , \qquad Eq . ( 25 )$$

where ρ₁, . . . , ρₙ are different possible shifting offset values, and r₀, . . . , rₙ are positive integers that indicate a range of possible codeword lengths of ΔC.

In an example, ΔC is calculated as a codeword length difference of xᵢ and xᵢ+1 as follows in equation (26):

$$Δ C = {C}_{{x}_{i} + 1} - {C}_{{x}_{i}} , \qquad Eq . ( 26 )$$

and the shifting offset

$${ρ}_{i}^{*}$$

is determined as follows in equation (27):

$${ρ}_{i}^{*} = \{ \begin{matrix}{ρ}_{1} , Δ C > c \\ {ρ}_{2} , Δ C \leq c\end{matrix} , \qquad Eq . ( 27 )$$

In an aspect, a lookup table is used to map the shifting offset

$${ρ}_{i}^{*}$$

value from ΔC.

In an aspect, a shifting operation, such as the shifting operation shown in equation (16), is not applied when ΔC is equal to a specified value or within a specified range.

In an example, shifting is not applied when ΔC=c. In an example, c is a predefined value for all transform coefficients. In an example, c is a predefined value that is adaptive to the transform coefficient location inside a block. In an example, c is signalled in a bitstream at one of a sequence level, a picture level, a slice level, a tile level, a block level, or other suitable levels.

In an example, shifting is not applied when ΔC>c. In an example, shifting is not applied when ΔC<c. In an example, shifting is not applied when c₁<ΔC<c₂.

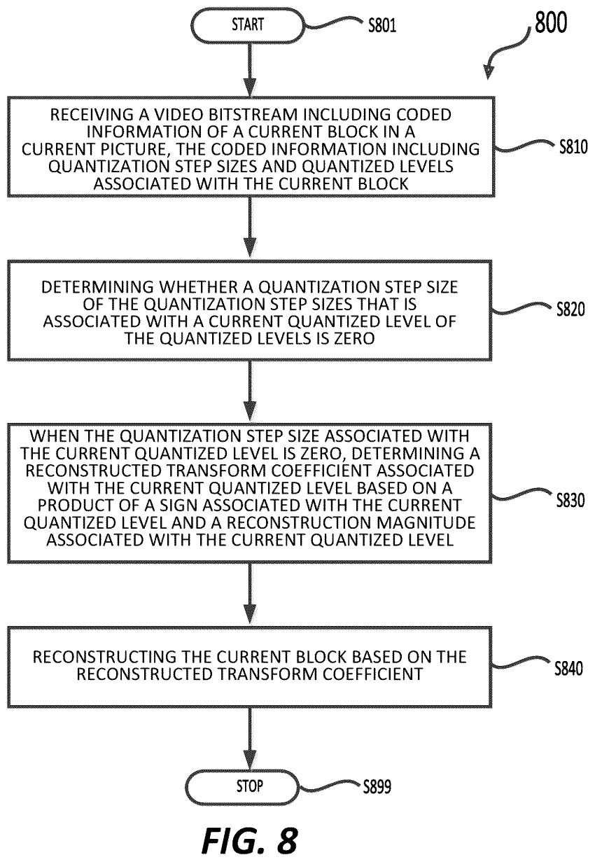

FIG. 8 shows a flow chart outlining a process (800) according to an aspect of the disclosure. The process (800) can be used in a video decoder. In various aspects, the process (800) is executed by processing circuitry, such as the processing circuitry that performs functions of the video decoder (110), the processing circuitry that performs functions of the video decoder (210), and the like. In some aspects, the process (800) is implemented in software instructions, thus when the processing circuitry executes the software instructions, the processing circuitry performs the process (800). The process starts at (S801) and proceeds to (S810).

At (S810), a video bitstream including coded information of a current block in a current picture is received. The coded information includes quantization step sizes and quantized levels associated with the current block.

At (S820), whether a quantization step size of the quantization step sizes that is associated with a current quantized level of the quantized levels is zero is determined.

At (S830), when the quantization step size associated with the current quantized level is zero, a reconstructed transform coefficient associated with the current quantized level is determined based on a product of a sign associated with the current quantized level and a reconstruction magnitude associated with the current quantized level.

At (S840), the current block is reconstructed based on the reconstructed transform coefficient.

In an aspect, the sign is determined as a most frequent one of signs of reconstructed neighboring transform coefficients.

In an aspect, the sign is determined as a most frequent one of signs of reconstructed neighboring transform coefficients when a percentage of the most frequent one of signs is larger than a threshold value. The percentage is a ratio of a total number of the most frequent one of the signs of the reconstructed neighboring transform coefficients and a total number of the signs of the reconstructed neighboring transform coefficients.

In an aspect, a plurality of sets of candidate reconstructed sample values of the current block is determined based on a plurality of sets of candidate signs. Each set of candidate reconstructed sample values is determined based on a respective set of candidate signs. A plurality of cost values is determined based on differences between the plurality of sets of candidate reconstructed sample values and reconstructed sample values of neighboring blocks of the current block. The sign associated with the current quantized level is determined as one of the plurality of candidate signs that corresponds to a minimum cost value of the plurality of cost values.

In an aspect, a first set of candidate reconstructed sample values of the current block is determined based on a first set of candidate signs. A first cost value is determined based on a first absolute sum of a plurality of differences between candidate reconstructed sample values in a current column of the current block and reconstructed sample values in a neighboring column of one of the neighboring blocks, and a second absolute sum of a plurality of differences between candidate reconstructed sample values in a current row of the current block and reconstructed sample values in a neighboring row of one of the neighboring blocks.

In an aspect, the reconstruction magnitude is determined as a sum of a first value and a second value. The first value is one of (i) a product of the quantization step size associated with the current quantized level and a first constant and (ii) a product of a location value of the current quantized level and the first constant, and the second value is a second constant.

In an aspect, the reconstruction magnitude is determined as a first constant when a parameter associated with the current quantized level is less than a threshold value, and a second constant when the parameter associated with the current quantized level is equal to or larger than the threshold value. The parameter is equal to one of (i) the quantization step size associated with the current quantized level, (ii) a location value of the current quantized level, and (iii) an absolute sum of neighboring quantized levels of the current quantized level.

In an aspect, the reconstruction magnitude is determined based on a location value of the current quantized level and a type of a transform kernel associated with the current quantized level.

Then, the process proceeds to (S899) and terminates.

The process (800) can be suitably adapted. Step(s) in the process (800) can be modified and/or omitted. Additional step(s) can be added. Any suitable order of implementation can be used.

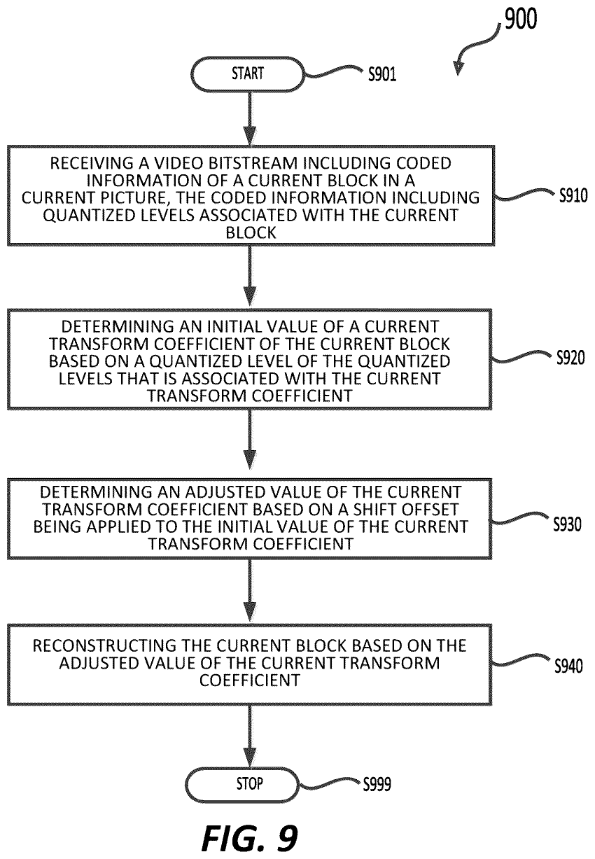

FIG. 9 shows a flow chart outlining a process (900) according to an aspect of the disclosure. The process (900) can be used in a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), a video bitstream including coded information of a current block in a current picture is received. The coded information includes quantized levels associated with the current block.

At (S920), an initial value of a current transform coefficient of the current block is determined based on a quantized level of the quantized levels that is associated with the current transform coefficient.

At (S930), an adjusted value of the current transform coefficient is determined based on a shift offset being applied to the initial value of the current transform coefficient.

At (S940), the current block is reconstructed based on the adjusted value of the current transform coefficient.

In an aspect, the shift offset is determined as a sum of a first value and a second value. The first value is a product of (i) a codeword length of the quantized level associated with the current transform coefficient and (ii) a first constant, and the second value is a second constant.

In an aspect, the shift offset is determined as a sum of a first value and a second value. The first value is a product of (i) a square of a codeword length of the quantized level associated with the current transform coefficient and (ii) a first constant, and the second value is a second constant.

In an aspect, the shift offset is determined as (i) a first value when a codeword length of the quantized level associated with the current transform coefficient is in a first range, and (ii) a second value when the codeword length of the quantized level associated with the current transform coefficient is in a second range.

In an aspect, the shift offset is determined from a look up table that indicates a mapping between codeword lengths of the quantized levels and shift offsets associated with the current block.

In an aspect, the shift offset is determined as zero based on a comparison between (i) a codeword length of the quantized level associated with the current transform coefficient and (ii) a constant value. The constant value is a predefined value that is adaptive to a location of the current transform coefficient.

In an aspect, the shift offset is determined as a sum of a first value and a second value. The first value is a product of (i) a codeword length difference associated with the quantized level of the current transform coefficient and (ii) a first constant. The second value is a second constant. The codeword length difference indicates a difference between a first codeword length of the quantized level associated with the current transform coefficient and a second codeword length of another quantized level associated with another transform coefficient. The other quantized level is equal to a sum of the quantized level of the current transform coefficient and a nonzero integer value.

In an aspect, the shift offset is determined as a sum of a first value and a second value. The first value is a product of (i) a square of a codeword length difference associated with the quantized level of the current transform coefficient and (ii) a first constant. The second value is a second constant. The codeword length difference indicates a difference between a first codeword length of the quantized level associated with the current transform coefficient and a second codeword length of another quantized level associated with another transform coefficient. The other quantized level is equal to a sum of the quantized level of the current transform coefficient and a nonzero integer value.

In an aspect, the shift offset is determined as (i) a first value when a codeword length difference associated with the quantized level of the current transform coefficient is in a first range, and (ii) a second value when the codeword length difference associated with the quantized level of the current transform coefficient is in a second range. The codeword length difference indicates a difference between a first codeword length of the quantized level associated with the current transform coefficient and a second codeword length of another quantized level associated with another transform coefficient. The other quantized level is equal to a sum of the quantized level and a nonzero integer value.

In an aspect, the shift offset is determined from a look up table that indicates a mapping between codeword length differences associated with the quantized levels of the current block and shift offsets associated with the current block. Each of the codeword length differences indicates a difference between a codeword length of one of the quantized levels and a codeword length of another one of the quantized levels.

In an aspect, the shift offset is determined as zero based on a comparison between a codeword length difference associated with the quantized level of the current transform coefficient and a constant value. The constant value is a predefined value that is adaptive to a location of the current transform coefficient. The codeword length difference indicates a difference between a first codeword length of the quantized level associated with the current transform coefficient and a second codeword length of another quantized level associated with another transform coefficient. The other quantized level is equal to a sum of the quantized level of the current transform coefficient and a nonzero integer value.

Then, the process proceeds to (S999) and terminates.

The process (900) can be suitably adapted. Step(s) in the process (900) can be modified and/or omitted. Additional step(s) can be added. Any suitable order of implementation can be used.

In an aspect, a method of processing visual media data includes processing a bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, a bitstream of the visual media data is processed according to a format rule. The bitstream includes coded information of a current block in a current picture. The coded information includes quantization step sizes and quantized levels associated with the current block. The format rule specifies that whether a quantization step size of the quantization step sizes that is associated with a current quantized level of the quantized levels is zero is determined. The format rule specifics that, when the quantization step size associated with the current quantized level is zero, a reconstructed transform coefficient associated with the current quantized level is determined based on a product of a sign associated with the current quantized level and a reconstruction magnitude associated with the current quantized level. The format rule specifics that the current block is processed based on the reconstructed transform coefficient.

In an example, a bitstream of the visual media data is processed according to a format rule. The bitstream includes coded information of a current block in a current picture. The coded information includes quantized levels associated with the current block. The format rule specifies that an initial value of a current transform coefficient of the current block is determined based on a quantized level of the quantized levels that is associated with the current transform coefficient. The format rule specifies that an adjusted value of the current transform coefficient is determined based on a shift offset being applied to the initial value of the current transform coefficient. The current block is processed based on the adjusted value of the current transform coefficient.

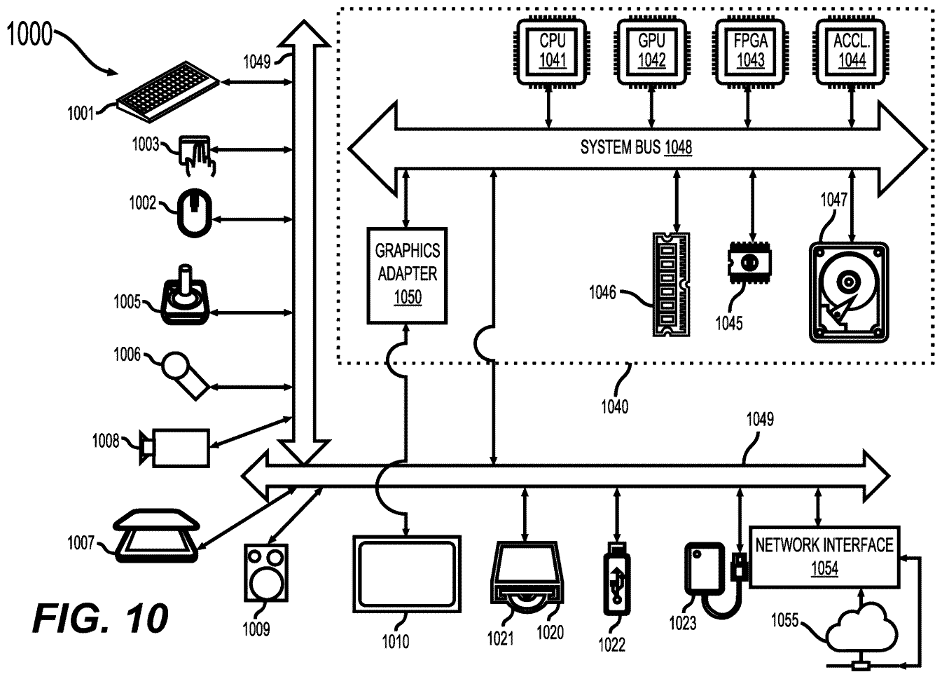

The techniques described above, can be implemented as computer software using computer-readable instructions and physically stored in one or more computer-readable media. For example, FIG. 10 shows a computer system (1000) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 10 for computer system (1000) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (1000).

Computer system (1000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1001), mouse (1002), trackpad (1003), touch screen (1010), data-glove (not shown), joystick (1005), microphone (1006), scanner (1007), camera (1008).

Computer system (1000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1010), data-glove (not shown), or joystick (1005), but there can also be tactile feedback devices that do not serve as input devices), audio output devices (such as: speakers (1009), headphones (not depicted)), visual output devices (such as screens (1010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1000) can also include human accessible storage devices and their associated media such as optical media including CD/DVD ROM/RW (1020) with CD/DVD or the like media (1021), thumb-drive (1022), removable hard drive or solid state drive (1023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1000) can also include an interface (1054) to one or more communication networks (1055). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1049) (such as, for example USB ports of the computer system (1000)); others are commonly integrated into the core of the computer system (1000) by attachment to a system bus as described below (for example Ethernet interface into a PC computer system or cellular network interface into a smartphone computer system). Using any of these networks, computer system (1000) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (1040) of the computer system (1000).

The core (1040) can include one or more Central Processing Units (CPU) (1041), Graphics Processing Units (GPU) (1042), specialized programmable processing units in the form of Field Programmable Gate Areas (FPGA) (1043), hardware accelerators for certain tasks (1044), graphics adapters (1050), and so forth. These devices, along with Read-only memory (ROM) (1045), Random-access memory (1046), internal mass storage such as internal non-user accessible hard drives, SSDs, and the like (1047), may be connected through a system bus (1048). In some computer systems, the system bus (1048) can be accessible in the form of one or more physical plugs to enable extensions by additional CPUs, GPU, and the like. The peripheral devices can be attached either directly to the core's system bus (1048), or through a peripheral bus (1049). In an example, the screen (1010) can be connected to the graphics adapter (1050). Architectures for a peripheral bus include PCI, USB, and the like.

CPUs (1041), GPUs (1042), FPGAs (1043), and accelerators (1044) can execute certain instructions that, in combination, can make up the aforementioned computer code. That computer code can be stored in ROM (1045) or RAM (1046). Transitional data can also be stored in RAM (1046), whereas permanent data can be stored for example, in the internal mass storage (1047). Fast storage and retrieve to any of the memory devices can be enabled through the use of cache memory, that can be closely associated with one or more CPU (1041), GPU (1042), mass storage (1047), ROM (1045), RAM (1046), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (1000), and specifically the core (1040) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (1040) that are of non-transitory nature, such as core-internal mass storage (1047) or ROM (1045). The software implementing various aspects of the present disclosure can be stored in such devices and executed by core (1040). A computer-readable medium can include one or more memory devices or chips, according to particular needs. The software can cause the core (1040) and specifically the processors therein (including CPU, GPU, FPGA, and the like) to execute particular processes or particular parts of particular processes described herein, including defining data structures stored in RAM (1046) and modifying such data structures according to the processes defined by the software. In addition or as an alternative, the computer system can provide functionality as a result of logic hardwired or otherwise embodied in a circuit (for example: accelerator (1044)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to Care intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of video decoding, the method including: receiving a video bitstream including coded information of a current block in a current picture, the coded information including quantization step sizes and quantized levels associated with the current block; determining whether a quantization step size of the quantization step sizes that is associated with a current quantized level of the quantized levels is zero; when the quantization step size associated with the current quantized level is zero, determining a reconstructed transform coefficient associated with the current quantized level based on a product of a sign associated with the current quantized level and a reconstruction magnitude associated with the current quantized level; and reconstructing the current block based on the reconstructed transform coefficient.

(2) The method of feature (1), in which the sign is determined as a most frequent one of signs of reconstructed neighboring transform coefficients.

(3) The method of any of features (1) and (2), in which the sign is determined as a most frequent one of signs of reconstructed neighboring transform coefficients when a percentage of the most frequent one of signs is larger than a threshold value, the percentage being a ratio of a total number of the most frequent one of the signs of the reconstructed neighboring transform coefficients and a total number of the signs of the reconstructed neighboring transform coefficients.

(4) The method of any of features (1) to (3), further including: determining a plurality of sets of candidate reconstructed sample values of the current block based on a plurality of sets of candidate signs, each set of candidate reconstructed sample values being determined based on a respective set of candidate signs; determining a plurality of cost values based on differences between the plurality of sets of candidate reconstructed sample values and reconstructed sample values of neighboring blocks of the current block; and determining the sign associated with the current quantized level as one of the plurality of candidate signs that corresponds to a minimum cost value of the plurality of cost values.

(5) The method of feature (4), in which the determining the plurality of cost values further includes: determining a first set of candidate reconstructed sample values of the current block based on a first set of candidate signs; and determining a first cost value based on a first absolute sum of a plurality of differences between candidate reconstructed sample values in a current column of the current block and reconstructed sample values in a neighboring column of one of the neighboring blocks, and a second absolute sum of a plurality of differences between candidate reconstructed sample values in a current row of the current block and reconstructed sample values in a neighboring row of one of the neighboring blocks.

(6) The method of any of features (1) to (5), in which the reconstruction magnitude is determined as a sum of a first value and a second value, the first value being one of (i) a product of the quantization step size associated with the current quantized level and a first constant and (ii) a product of a location value of the current quantized level and the first constant, and the second value being a second constant.

(7) The method of any of features (1) to (6), in which the reconstruction magnitude is determined as a first constant when a parameter associated with the current quantized level is less than a threshold value, and a second constant when the parameter associated with the current quantized level is equal to or larger than the threshold value, the parameter being equal to one of (i) the quantization step size associated with the current quantized level, (ii) a location value of the current quantized level, and (iii) an absolute sum of neighboring quantized levels of the current quantized level.

(8) The method of any of features (1) to (7), in which the reconstruction magnitude is determined based on a location value of the current quantized level and a type of a transform kernel associated with the current quantized level.

(9) A method of video decoding, including: receiving a video bitstream including coded information of a current block in a current picture, the coded information including quantized levels associated with the current block; determining an initial value of a current transform coefficient of the current block based on a quantized level of the quantized levels that is associated with the current transform coefficient; determining an adjusted value of the current transform coefficient based on a shift offset being applied to the initial value of the current transform coefficient; and reconstructing the current block based on the adjusted value of the current transform coefficient.

(10) The method of feature (9), in which the determining the adjusted value of the current transform coefficient further includes: determined the shift offset as a sum of a first value and a second value, the first value being a product of (i) a codeword length of the quantized level associated with the current transform coefficient and (ii) a first constant, and the second value being a second constant.

(11) The method of any of features (9) and (10), in which the determining the adjusted value of the current transform coefficient further includes: determining the shift offset as a sum of a first value and a second value, the first value being a product of (i) a square of a codeword length of the quantized level associated with the current transform coefficient and (ii) a first constant, and the second value being a second constant.

(12) The method of any of features (9) to (11), in which the determining the adjusted value of the current transform coefficient further includes: determining the shift offset as (i) a first value when a codeword length of the quantized level associated with the current transform coefficient is in a first range, and (ii) a second value when the codeword length of the quantized level associated with the current transform coefficient is in a second range.

(13) The method of any of features (9) to (12), in which the determining the adjusted value of the current transform coefficient further includes: determining the shift offset from a look up table that indicates a mapping between codeword lengths of the quantized levels and shift offsets associated with the current block.

(14) The method of any of features (9) to (13), in which the determining the adjusted value of the current transform coefficient further includes: determining the shift offset as zero based on a comparison between (i) a codeword length of the quantized level associated with the current transform coefficient and (ii) a constant value, the constant value being a predefined value that is adaptive to a location of the current transform coefficient.

(15) The method of any of features (9) to (14), in which the determining the adjusted value of the current transform coefficient further includes: determining the shift offset as a sum of a first value and a second value, the first value being a product of (i) a codeword length difference associated with the quantized level of the current transform coefficient and (ii) a first constant, the second value being a second constant, the codeword length difference indicating a difference between a first codeword length of the quantized level associated with the current transform coefficient and a second codeword length of another quantized level associated with another transform coefficient, the other quantized level being equal to a sum of the quantized level of the current transform coefficient and a nonzero integer value.

(16) The method of any of features (9) to (15), in which the determining the adjusted value of the current transform coefficient further includes: determining the shift offset as a sum of a first value and a second value, the first value being a product of (i) a square of a codeword length difference associated with the quantized level of the current transform coefficient and (ii) a first constant, the second value being a second constant, and the codeword length difference indicating a difference between a first codeword length of the quantized level associated with the current transform coefficient and a second codeword length of another quantized level associated with another transform coefficient, the other quantized level being equal to a sum of the quantized level of the current transform coefficient and a nonzero integer value.

(17) The method of any of features (9) to (16), in which the determining the adjusted value of the current transform coefficient further includes: determining the shift offset as (i) a first value when a codeword length difference associated with the quantized level of the current transform coefficient is in a first range, and (ii) a second value when the codeword length difference associated with the quantized level of the current transform coefficient is in a second range, the codeword length difference indicating a difference between a first codeword length of the quantized level associated with the current transform coefficient and a second codeword length of another quantized level associated with another transform coefficient, the other quantized level being equal to a sum of the quantized level and a nonzero integer value.

(18) The method of any of features (9) to (17), in which the determining the adjusted value of the current transform coefficient further includes: determining the shift offset from a look up table that indicates a mapping between codeword length differences associated with the quantized levels of the current block and shift offsets associated with the current block, each of the codeword length differences indicating a difference between a codeword length of one of the quantized levels and a codeword length of another one of the quantized levels.

(19) The method of any of features (9) to (18), in which the determining the adjusted value of the current transform coefficient further includes: determining the shift offset as zero based on a comparison between a codeword length difference associated with the quantized level of the current transform coefficient and a constant value, the constant value being a predefined value that is adaptive to a location of the current transform coefficient, the codeword length difference indicating a difference between a first codeword length of the quantized level associated with the current transform coefficient and a second codeword length of another quantized level associated with another transform coefficient, the other quantized level being equal to a sum of the quantized level of the current transform coefficient and a nonzero integer value.

(20) A method of processing visual media data, the method includes: processing a bitstream of the visual media data according to a format rule, in which: the bitstream includes coded information of a current block in a current picture, the coded information including quantization step sizes and quantized levels associated with the current block; and the format rule specifies that: whether a quantization step size of the quantization step sizes that is associated with a current quantized level of the quantized levels is zero is determined; when the quantization step size associated with the current quantized level is zero, a reconstructed transform coefficient associated with the current quantized level is determined based on a product of a sign associated with the current quantized level and a reconstruction magnitude associated with the current quantized level; and the current block is processed based on the reconstructed transform coefficient.

(21) An apparatus for video decoding, including processing circuitry that is configured to perform the method of any of features (1) to (8).

(22) An apparatus for video decoding, including processing circuitry that is configured to perform the method of any of features (9) to (19).

(23) A non-transitory computer-readable storage medium storing instructions which when executed by at least one processor cause the at least one processor to perform the method of any of features (1) to (19).

What is claimed is:

1. A method of video decoding, the method comprising:
receiving a video bitstream including coded information of a current block in a current picture, the coded information including quantization step sizes and quantized levels associated with the current block;
determining whether a quantization step size of the quantization step sizes that is associated with a current quantized level of the quantized levels is zero;
when the quantization step size associated with the current quantized level is zero, determining a reconstructed transform coefficient associated with the current quantized level based on a product of a sign associated with the current quantized level and a reconstruction magnitude associated with the current quantized level; and
reconstructing the current block based on the reconstructed transform coefficient.

2. The method of claim 1, wherein the sign is determined as a most frequent one of signs of reconstructed neighboring transform coefficients.

3. The method of claim 1, wherein the sign is determined as a most frequent one of signs of reconstructed neighboring transform coefficients when a percentage of the most frequent one of signs is larger than a threshold value, the percentage being a ratio of a total number of the most frequent one of the signs of the reconstructed neighboring transform coefficients and a total number of the signs of the reconstructed neighboring transform coefficients.

4. The method of claim 1, further comprising:
determining a plurality of sets of candidate reconstructed sample values of the current block based on a plurality of sets of candidate signs, each set of candidate reconstructed sample values being determined based on a respective set of candidate signs;
determining a plurality of cost values based on differences between the plurality of sets of candidate reconstructed sample values and reconstructed sample values of neighboring blocks of the current block; and
determining the sign associated with the current quantized level as one of the plurality of candidate signs that corresponds to a minimum cost value of the plurality of cost values.

5. The method of claim 4, wherein the determining the plurality of cost values further comprises:
determining a first set of candidate reconstructed sample values of the current block based on a first set of candidate signs; and
determining a first cost value based on a first absolute sum of a plurality of differences between candidate reconstructed sample values in a current column of the current block and reconstructed sample values in a neighboring column of one of the neighboring blocks, and a second absolute sum of a plurality of differences between candidate reconstructed sample values in a current row of the current block and reconstructed sample values in a neighboring row of one of the neighboring blocks.

6. The method of claim 1, wherein the reconstruction magnitude is determined as a sum of a first value and a second value, the first value being one of (i) a product of the quantization step size associated with the current quantized level and a first constant and (ii) a product of a location value of the current quantized level and the first constant, and the second value being a second constant.

7. The method of claim 1, wherein the reconstruction magnitude is determined as a first constant when a parameter associated with the current quantized level is less than a threshold value, and a second constant when the parameter associated with the current quantized level is equal to or larger than the threshold value, the parameter being equal to one of (i) the quantization step size associated with the current quantized level, (ii) a location value of the current quantized level, and (iii) an absolute sum of neighboring quantized levels of the current quantized level.

8. The method of claim 1, wherein the reconstruction magnitude is determined based on a location value of the current quantized level and a type of a transform kernel associated with the current quantized level.

9. A method of video decoding, comprising:
receiving a video bitstream including coded information of a current block in a current picture, the coded information including quantized levels associated with the current block;
determining an initial value of a current transform coefficient of the current block based on a quantized level of the quantized levels that is associated with the current transform coefficient;
determining an adjusted value of the current transform coefficient based on a shift offset being applied to the initial value of the current transform coefficient; and
reconstructing the current block based on the adjusted value of the current transform coefficient.

10. The method of claim 9, wherein the determining the adjusted value of the current transform coefficient further comprises:
determined the shift offset as a sum of a first value and a second value, the first value being a product of (i) a codeword length of the quantized level associated with the current transform coefficient and (ii) a first constant, and the second value being a second constant.

11. The method of claim 9, wherein the determining the adjusted value of the current transform coefficient further comprises:
determining the shift offset as a sum of a first value and a second value, the first value being a product of (i) a square of a codeword length of the quantized level associated with the current transform coefficient and (ii) a first constant, and the second value being a second constant.

12. The method of claim 9, wherein the determining the adjusted value of the current transform coefficient further comprises:
determining the shift offset as (i) a first value when a codeword length of the quantized level associated with the current transform coefficient is in a first range, and (ii) a second value when the codeword length of the quantized level associated with the current transform coefficient is in a second range.

13. The method of claim 9, wherein the determining the adjusted value of the current transform coefficient further comprises:
determining the shift offset from a look up table that indicates a mapping between codeword lengths of the quantized levels and shift offsets associated with the current block.

14. The method of claim 9, wherein the determining the adjusted value of the current transform coefficient further comprises:
determining the shift offset as zero based on a comparison between (i) a codeword length of the quantized level associated with the current transform coefficient and (ii) a constant value, the constant value being a predefined value that is adaptive to a location of the current transform coefficient.

15. The method of claim 9, wherein the determining the adjusted value of the current transform coefficient further comprises:
determining the shift offset as a sum of a first value and a second value, the first value being a product of (i) a codeword length difference associated with the quantized level of the current transform coefficient and (ii) a first constant, the second value being a second constant, the codeword length difference indicating a difference between a first codeword length of the quantized level associated with the current transform coefficient and a second codeword length of another quantized level associated with another transform coefficient, the other quantized level being equal to a sum of the quantized level of the current transform coefficient and a nonzero integer value.

16. The method of claim 9, wherein the determining the adjusted value of the current transform coefficient further comprises:
determining the shift offset as a sum of a first value and a second value, the first value being a product of (i) a square of a codeword length difference associated with the quantized level of the current transform coefficient and (ii) a first constant, the second value being a second constant, and the codeword length difference indicating a difference between a first codeword length of the quantized level associated with the current transform coefficient and a second codeword length of another quantized level associated with another transform coefficient, the other quantized level being equal to a sum of the quantized level of the current transform coefficient and a nonzero integer value.

17. The method of claim 9, wherein the determining the adjusted value of the current transform coefficient further comprises:
determining the shift offset as (i) a first value when a codeword length difference associated with the quantized level of the current transform coefficient is in a first range, and (ii) a second value when the codeword length difference associated with the quantized level of the current transform coefficient is in a second range, the codeword length difference indicating a difference between a first codeword length of the quantized level associated with the current transform coefficient and a second codeword length of another quantized level associated with another transform coefficient, the other quantized level being equal to a sum of the quantized level and a nonzero integer value.

18. The method of claim 9, wherein the determining the adjusted value of the current transform coefficient further comprises:
determining the shift offset from a look up table that indicates a mapping between codeword length differences associated with the quantized levels of the current block and shift offsets associated with the current block, each of the codeword length differences indicating a difference between a codeword length of one of the quantized levels and a codeword length of another one of the quantized levels.

19. The method of claim 9, wherein the determining the adjusted value of the current transform coefficient further comprises:
determining the shift offset as zero based on a comparison between a codeword length difference associated with the quantized level of the current transform coefficient and a constant value, the constant value being a predefined value that is adaptive to a location of the current transform coefficient, the codeword length difference indicating a difference between a first codeword length of the quantized level associated with the current transform coefficient and a second codeword length of another quantized level associated with another transform coefficient, the other quantized level being equal to a sum of the quantized level of the current transform coefficient and a nonzero integer value.

20. A method of processing visual media data, the method comprising:
processing a bitstream of the visual media data according to a format rule, wherein:
the bitstream includes coded information of a current block in a current picture, the coded information including quantization step sizes and quantized levels associated with the current block; and
the format rule specifies that:
whether a quantization step size of the quantization step sizes that is associated with a current quantized level of the quantized levels is zero is determined;
when the quantization step size associated with the current quantized level is zero, a reconstructed transform coefficient associated with the current quantized level is determined based on a product of a sign associated with the current quantized level and a reconstruction magnitude associated with the current quantized level; and
the current block is processed based on the reconstructed transform coefficient.
